(19) United States
(12) Patent Application Publication
(10) Pub. No.: US 2011/0227479 A1
(43) Pub. Date: Sep. 22, 2011

(54) PLASMA DISPLAY PANEL, METHOD FOR MANUFACTURING THE SAME, AND PLASMA DISPLAY APPARATUS

(76) Inventors: Reiko Taniguchi, Osaka (JP); Koyo Sakamoto, Osaka (JP); Masaki Nishimura, Osaka (JP); Ken Ito, Osaka (JP); Masayuki Ono, Osaka (JP)

(21) Appl. No.: 13/058,280

(22) PCT Filed: Aug. 25, 2010
(86) PCT No.: PCT/JP2010/005218

§ 371 Date: Feb. 9, 2011

(30) Foreign Application Priority Data
Aug. 25, 2009 (JP) 2009-194003

(51) Int. Cl. H01J 17/49; H01J 9/20

(52) U.S. Cl. 313/587; 445/58

(57) ABSTRACT

A plasma display panel includes: a front plate having a dielectric layer that is formed to cover display electrodes formed on a substrate, and a protective film that is formed on the dielectric layer; and a rear plate disposed facing the front plate so as to form a discharge space, which has a data electrode formed in a direction intersecting the display electrodes and has barrier ribs for partitioning the discharge space. The protective film is composed of oxide particles of a Group 2 component and contains phosphorus.

### TECHNICAL FIELD

The technology disclosed herein relates to a plasma display panel as a display device, a method for manufacturing thereof, and a plasma display apparatus.

### BACKGROUND ART

A plasma display panel (hereinafter, referred to as PDP) is commercialized for use in a 65-inch size television receiver and the like because the PDP is capable of providing higher definition and a larger screen. Recently, PDPs have been extending their applications to high-definition televisions in which the number of scan lines is at least twice that of the conventional NTSC system. In addition, such PDPs are required not to contain lead components in view of environmental issues.

The PDP basically includes a front plate and a rear plate. The front plate includes: a glass substrate composed of borosilicate sodium glass by a float process; display electrodes including a stripe-shaped transparent electrode and a stripe-shaped bus electrode, both formed on one main surface of the glass substrate; a dielectric layer covering the display electrodes and functioning as a capacitor; and a protective film composed of magnesium oxide (MgO) formed on the dielectric layer. On the other hand, the rear plate includes: a glass substrate; a stripe-shaped data electrode formed on one main surface of the glass substrate; an underlying dielectric layer covering the data electrode; barrier ribs formed on the underlying dielectric layer; and phosphor layers formed between the barrier ribs, which each emit light of red, green, or blue.

Here, the protective film serves a role (sputter resistance) in protecting the dielectric layer and the electrodes from ion bombardment occurring during a gas discharge. The protective film also serves another role in holding charges during the discharge by means of emitting secondary electrons, i.e., so called a memory function. Therefore, for such protective film, a metal oxide film including magnesium oxide (MgO) is commonly used which is excellent in ion bombardment resistance (sputter resistance) and secondary electron emission capability (for example, see Patent Literature 1).

As described above, the roles of the protective film formed on the dielectric layer of the front plate include: protecting the dielectric layer from ion bombardment caused by a discharge, and emitting initial electrons so as to generate an address discharge.

Protecting the dielectric layer from ion bombardment is an important role in preventing an increase in discharge voltage. Emitting initial electrons to generate an address discharge is an important role in preventing an address discharge error that may cause flicker of an image.

### CITATION LIST

### Patent Literature

Patent Literature 1: Japanese Patent Unexamined Publication No. 2007-48733

### SUMMARY OF THE INVENTION

A plasma display panel disclosed herein is characterized in that the panel includes: a front plate having a dielectric layer that is formed to cover display electrodes formed on a substrate and having a protective film that is formed on the dielectric layer; and a rear plate disposed facing the front plate so as to form a discharge space, which has a data electrode formed in a direction intersecting the display electrodes and has barrier ribs for partitioning the discharge space. And, the protective film includes oxide particles of a Group 2 element and contains phosphorus.

The method disclosed herein is a method for manufacturing a plasma display panel, which is characterized in that the method includes: a front plate having a dielectric layer that is formed to cover display electrodes formed on a substrate and having a protective film that is formed on the dielectric layer; and a rear plate disposed facing the front plate so as to form a discharge space, which has a data electrode formed in a direction intersecting the display electrodes and has barrier ribs for partitioning the discharge space. And, the protective film is formed by applying and firing a paste that includes oxide particles of a Group 2 element, and a phosphate of a Group 2 element or an organic phosphate compound.

A plasma display apparatus disclosed herein is characterized in that the apparatus includes a plasma display panel which includes: a front plate having a dielectric layer that is formed to cover display electrodes formed on a substrate and having a protective film that is formed on the dielectric layer; a rear plate disposed facing the front plate so as to form a discharge space, which has a data electrode formed in a direction intersecting the display electrodes and has barrier ribs for partitioning the discharge space; and a plurality of discharge cells. And, the plasma display apparatus performs light-emitting display in such a manner that one field is composed of a plurality of subfields, and that each of the subfields includes: an address period for generating address discharges to select discharge cells which should emit light; and a sustain period for generating sustain discharges in the cells selected during the address period. And, the protective film of the plasma display panel includes oxide particles of a Group 2 element and contains phosphorus.

According to the technology disclosed herein, the protective film is formed by applying and firing a paste that contains oxide particles of a Group 2 element, and a phosphate of a Group 2 element or an organic phosphate compound, and phosphorus is contained in the protective film including the oxide particles of the Group 2 element. This allows the protective film to be formed by a simple process without use of expensive equipment such as a vacuum vapor deposition apparatus. Particularly, since phosphorus is contained in the protective film including the oxide particles of the Group 2 element, it is possible to obtain a reduced discharge starting voltage and a longer operating life.

### BRIEF DESCRIPTION OF DRAWINGS

FIG. 1 is a perspective view showing a structure of a PDP of an embodiment.

FIG. 2 is an electrode arrangement diagram of the PDP.

FIG. 3 is a circuit block diagram of a plasma display apparatus using a PDP of an embodiment.

FIG. 4 is a chart of driving voltage waveforms that are applied respectively to electrodes of the PDP.

FIG. 5 is a cross sectional view showing a configuration of a front plate of the PDP.

FIG. 6 is a schematic magnified illustration of a portion of a protective film of the PDP.

FIG. 7 is a process flowchart of forming a protective film in a manufacturing method of a PDP of an embodiment.

FIG. 8 is a graph showing characteristics of discharge starting voltage by comparison, which are resulted from an experiment performed for demonstrating an advantage of a PDP of an embodiment.

FIG. 9 is a graph showing operating lives associated with discharges by comparison, which are resulted from an experiment performed for demonstrating an advantage of a PDP of an embodiment.

### DETAILED DESCRIPTION OF PREFERRED EMBODIMENTS

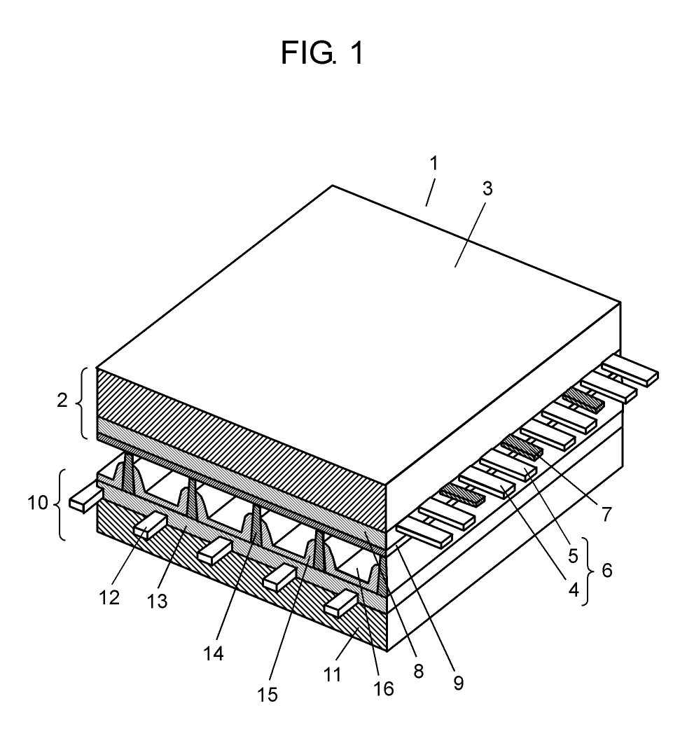

Hereinafter, a PDP according to an embodiment will be described, referring to FIGS. 1 to 9. FIG. 1 is a perspective view showing a structure of the PDP of the embodiment. In FIG. 1, the basic structure of PDP 1 is the same as that of commonly-used AC surface discharge PDPs. In PDP 1, front plate 2 composed of such as front glass substrate 3 and rear plate 10 composed of such as rear glass substrate 11 are disposed to face one another, and the peripheries thereof are hermetically sealed with a sealing material including a glass frit. In discharge space 16 inside sealed PDP 1, a discharge gas including Ne and Xe is enclosed at a pressure of 400 Ton to 600 Torr (5.3×10⁴ Pa to 8.0×10⁴ Pa).

On front glass substrate 3 of front plate 2, a pair of band-shaped display electrodes 6, composed of scan electrode 4 and sustain electrode 5, and light shielding layer 7 serving as a black stripe are disposed in parallel with one another in a plurality of rows. Dielectric layer 8 functioning as a capacitor is formed on front glass substrate 3 so as to cover display electrodes 6 and light shielding layers 7. In addition, protective layer 9 is formed on the surface of such dielectric layer.

Here, scan electrode 4 and sustain electrode 5 are each configured by forming a bus electrode composed of Ag on a transparent electrode which is composed of a conductive metal oxide such as ITO, SnO2, or ZnO.

On rear glass substrate 11 of rear plate 10, a plurality of data electrodes 12 composed of a conductive material containing Ag as a major component are disposed in parallel with one another in the direction perpendicular to scan electrode 4 and sustain electrode 5 of front plate 2. Such data electrodes are covered by underlying dielectric layer 13. In addition, barrier ribs 14 of a predetermined height are formed on underlying dielectric layer 13 between data electrodes 12 so as to partition discharge space 16. Phosphor layers 15, which each emit light of red, green, or blue by ultraviolet light, are sequentially coated and formed in grooves between barrier ribs 14, in manner of one layer for each of data electrodes 12. Discharge cells are formed at positions where data electrodes 12 intersect both scan electrodes 4 and sustain electrodes 5, and such discharge cells, which each have phosphor layer 15 of red, green, or blue, are arranged in the direction of display electrodes 6 to serve as pixels for a color display.

Note that, in the technology disclosed herein, the discharge gas enclosed in discharge space 16 is a mixed discharge gas which contains xenon in concentration from 10% to 30% by volume percent of the discharge gas.

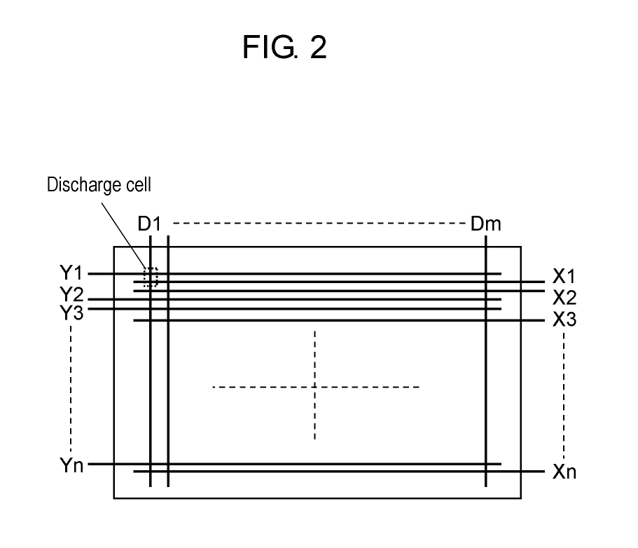

FIG. 2 is an electrode arrangement diagram of the PDP of the embodiment. N-lines of scan electrodes Y1, Y2, Y3, . . . , Yn (scan electrodes 4 of FIG. 1) elongated in the row direction and n-lines of sustain electrodes X1, X2, X3, . . . , Xn (sustain electrodes 5 of FIG. 1) elongated in the row direction are arranged; m-lines of data electrodes D1, D2, D3, . . . , Dm (data electrodes 12 of FIG. 1) elongated in the column direction are arranged. And, a discharge cell is formed at the intersection of one data electrode D1 and a pair of scan electrode Y1 and sustain electrode X1; m×n discharge cells are formed in the discharge space. These electrodes are respectively coupled with connection terminals disposed at peripheral edges on the outside of image display areas of front plate 2 and rear plate 10.

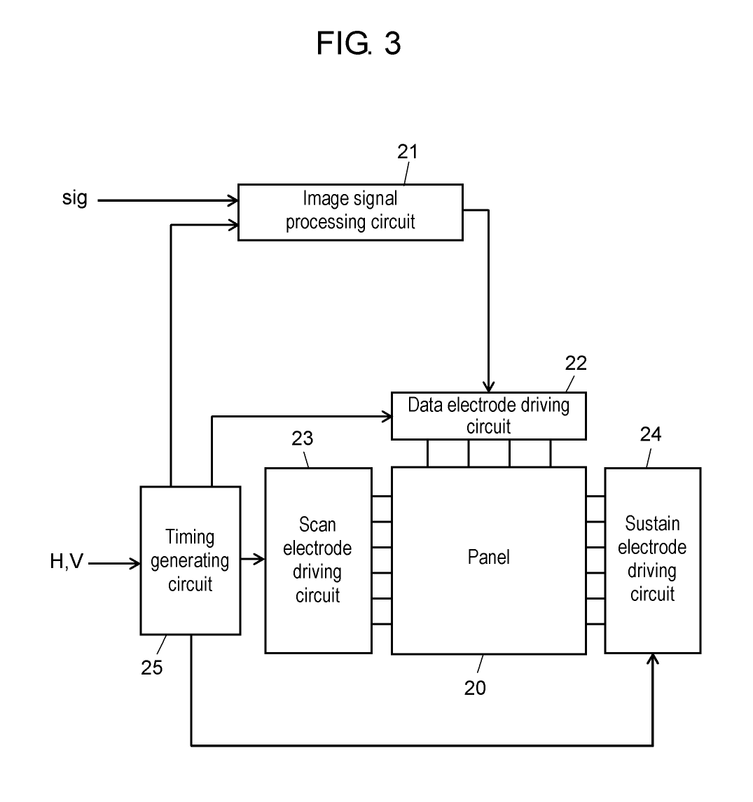

FIG. 3 is a circuit block diagram of a plasma display apparatus using a PDP of an embodiment. The plasma display apparatus includes PDP 1 of the configuration described above, image signal processing circuit 21, data electrode driving circuit 22, scan electrode driving circuit 23, sustain electrode driving circuit 24, timing generating circuit 25, and a power supply circuit (not shown).

Image signal processing circuit 21 converts an image signal “sig” into image data of every subfield. Data electrode driving circuit 22 converts the image data of every subfield into signals corresponding respectively to data electrodes D1 to Dm, and drives each of data electrodes D1 to Dm. Timing generating circuit 25 generates various timing signals in accordance with horizontal synchronizing signal H and vertical synchronizing signal V, and supplies the generated timing signals to every driving circuit block. Scan electrode driving circuit 23 supplies driving voltage waveforms to scan electrodes SC1 to SCn in accordance with the timing signals; sustain electrode driving circuit 24 supplies driving voltage waveforms to sustain electrodes SU1 to SUn in accordance with the timing signals.

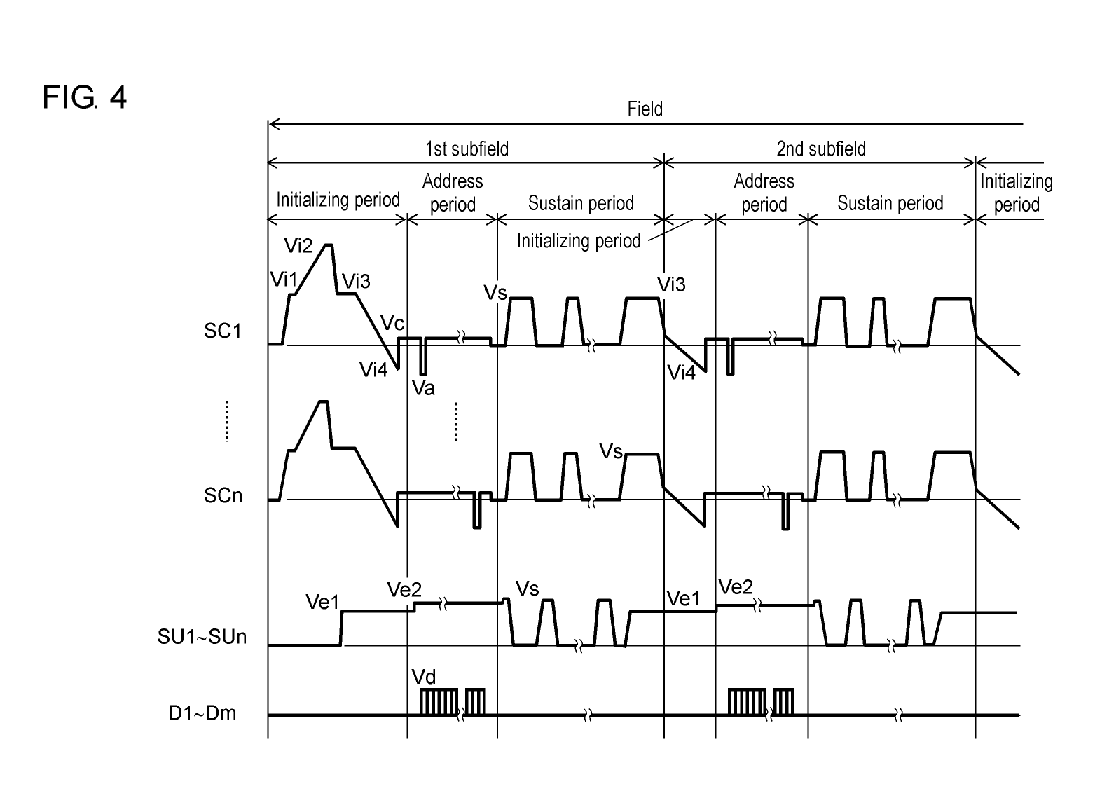

Next, referring to FIG. 4, the driving voltage waveforms for driving the PDP and operations thereof will be described. FIG. 4 is a chart of the driving voltage waveforms which are applied respectively to electrodes of the PDP.

In the plasma display apparatus of the embodiment, one field is composed of a plurality of subfields. Each of the subfields includes: an initializing period for generating initializing discharges in the discharge cells; an address period, after the initializing period, for generating address discharges to select discharge cells which should emit light; and a sustain period for generating sustain discharges in the discharge cells selected during the address period.

In an initializing period of a first subfield, data electrodes D1 to Dm and sustain electrodes SU1 to SUn are held at zero (V), and a ramp voltage is applied to scan electrodes SC1 to SCn, with the ramp voltage gradually rising from voltage Vi1 (V) of a discharge starting voltage or less toward voltage Vi2 (V) in excess of the discharge starting voltage. With this configuration, first-time weak initializing discharges are generated in all the discharge cells, which results in accumulations of negative wall voltages on scan electrodes SC1 to SCn and accumulations of positive wall voltages on both sustain electrodes SU1 to SUn and data electrodes D1 to Dm. Here, the term “wall voltages on electrodes” represents voltages caused by wall charges which accumulate on such as dielectric layers and phosphor layers that cover the electrodes.

After that, sustain electrodes SU1 to SUn are held at positive voltages Ve1 and Ve2 (V), and a ramp voltage is applied to scan electrodes SC1 to SCn, with the ramp voltage gradually descending from voltage V13 (V) toward voltage Vi4 (V). This causes second-time weak initializing discharges in all the discharge cells, which results in a decrease in wall voltages between portions on scan electrodes SC1 to SCn and portions on sustain electrodes SU1 to SUn, with the wall voltages on data electrodes D1 to Dm being adjusted to be suitable for an address operation.

In the subsequent address period, scan electrodes SC1 to SCn are once held at Vc (V). Next, while a negative scan pulse voltage Va (V) is applied to the first row of scan electrode SC1, a positive address pulse voltage Vd (V) is applied to data electrodes Dk (k=1 to m) of discharge cells to be in a display mode in the first row, out of data electrodes D1 to Dm. With this configuration, a voltage at the intersection of data electrode Dk and scan electrode SC1 is one that an external applied voltage (Vd−Va) (V) is added with the wall voltages on data electrode Dk and scan electrode SC1, which excesses the discharge starting voltage. Then, an address discharge occurs between data electrode Dk and scan electrode SC1 and between sustain electrode SU1 and scan electrode SC1. This results in accumulations of a positive wall voltage on scan electrode SC1, a negative wall voltage on sustain electrode SU1, and also a negative wall voltage on data electrode Dk of the discharge cell.

In this way, the address operation is performed to accumulate the wall voltage on the every electrode by means of generating the address discharges in the cells to be in a display mode in the first row. On the other hand, voltages at intersections of scan electrode SC1 and data electrodes D1 to Dm to which the address pulse voltage Vd (V) is not applied, do not exceed the discharge starting voltage; therefore, no address discharge occurs. The aforementioned address operation is sequentially performed through to the nth row of the discharge cells, and then the address period is completed.

In the subsequent sustain period, a positive sustain pulse voltage Vs (V) as a first voltage is applied to scan electrodes SC1 to SCn, and ground potential, i.e., zero (V) as a second voltage is applied to sustain electrodes SU1 to SUn. With this configuration, in the discharge cells where the address discharges have occurred, the voltages between the portions on scan electrode SCi and the portions on sustain electrode SUi are each a voltage that sustain pulse voltage Vs (V) is added with the wall voltages on scan electrode SCi and sustain electrode SUi, which excesses the discharge starting voltage. Then, sustain discharges occur between scan electrode SCi and sustain electrode SUi, thereby generating ultraviolet light by which the phosphor layers emit light. This results in accumulations of a negative wall voltage on scan electrode SCi, a positive wall voltage on sustain electrode SUi, and also a positive wall voltage on data electrode Dk.

In discharge cells where the address discharges did not occur in the address period, no sustain discharge occurs, and the wall voltages thereof at the end of the initializing period are held. Subsequently, the second voltage, i.e., zero (V) is applied to scan electrodes SC1 to SCn, and the first voltage, i.e., sustain pulse voltage Vs (V) is applied to sustain electrodes SU1 to SUn. With this configuration, in discharge cells where the sustain discharges have occurred, since the voltages between the portions on sustain electrode SUi and the portions on scan electrode SCi excess the discharge starting voltage, sustain discharges occur again between sustain electrode SUi and scan electrode SCi. This results in accumulations of negative wall voltages on sustain electrode SUi and positive wall voltages on scan electrode SCi.

In a similar way hereinafter, sustain pulses the number of which corresponds to a brightness weight, are applied alternately to scan electrodes SC1 to SCn and sustain electrodes SU1 to SUn. This results in a consecutive occurrence of the sustain discharges in the discharge cells where the address discharges occurred in the address period. Then, the sustain operation during the sustain period is completed.

In the second subfield and successive ones, since operations of an initializing period, address period, and sustain period are substantially equal to those in the first subfield, their explanations are omitted. Note that, in the embodiment, in the second subfield and successive ones, sustain electrodes SU1 to SUn are held at positive voltages Ve1 and Ve2, and a ramp voltage is applied to scan electrodes SC1 to SCn, with the ramp voltage gradually descending from voltage Vi3 (V) toward voltage Vi4 (V). This allows weak initializing discharges to occur only in discharge cells where the sustain discharges occurred in the preceding subfield. That is, the operation is configured such that, in the first subfield, initialization discharges occur in all discharge cells, i.e., an all-cell initialization operation, and that, in the second subfield and successive ones, initialization discharges occur selectively only in discharge cells where the sustain discharges occurred in the preceding subfield, i.e., a selective initialization operation. Note that, as in the embodiment, the all-cell initialization operation and selective initialization operation are respectively assigned to the first subfield and the other subfields; however, the all-cell initialization operation may be performed in a initialization period of a subfield other than the first subfield, or may be performed once in several fields.

And, while the operations of the initializing period and the address period are equal to those of the driving method in the first subfield described above, light emission by sustain discharges in the sustain period is driven by controlling a brightness weight of every subfield in such a manner that sustain pulses the number of which corresponds to the brightness weight are applied.

The technology disclosed herein provides, in such a plasma display apparatus, a display apparatus that features lower power consumption, display performance of higher-definition and brightness, and a lower price, by improving protective film 9 of PDP 1. Details of a characterized configuration thereof will be described hereinafter.

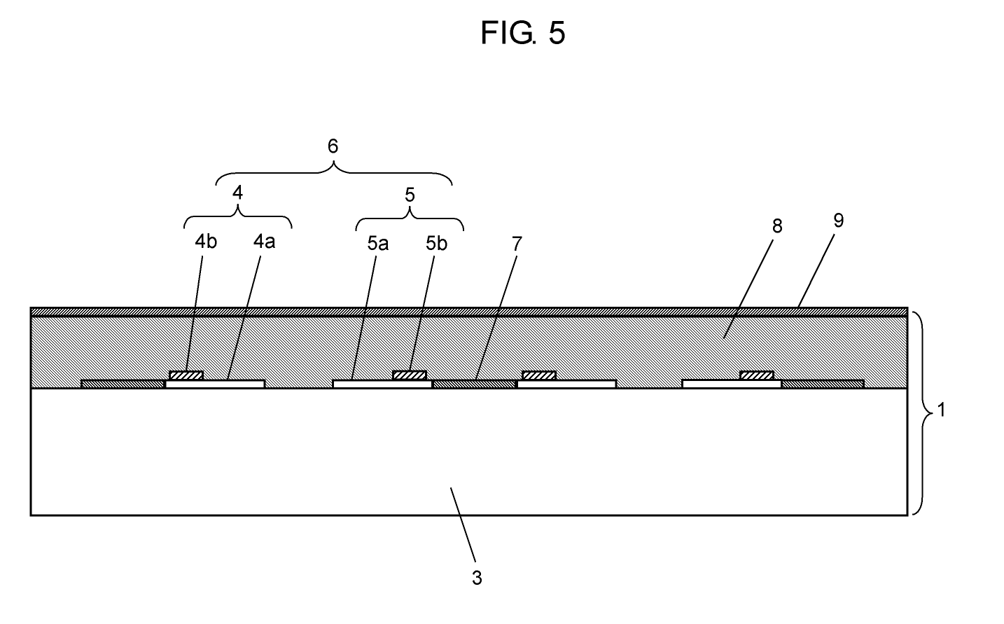

FIG. 5 is a cross sectional view showing a configuration of a front plate of the PDP of the embodiment, in an upside down manner from FIG. 1. As shown in FIG. 5, light shielding layers 7 and display electrodes 6 composed of scan electrode 4 and sustain electrode 5 are patterned and formed on front glass substrate 3 manufactured by a float process or the like. Scan electrode 4 and sustain electrode 5 include respectively: transparent electrodes 4a, 5a composed of such as indium tin oxide (ITO) or tin oxide (SnO₂); and metal bus electrodes 4b, 5b formed on transparent electrodes 4a, 5a, respectively. Metal bus electrodes 4b, 5b are used to provide electrical conductivity for transparent electrodes 4a, 5a in the longitudinal direction thereof, and are composed of a conductive material containing a silver (Ag) material as a major component.

Dielectric layer 8 is disposed to cover these transparent electrodes 4a, 5a, metal bus electrodes 4b, 5b, and light shielding layers 7, which are formed on front glass substrate 3. And, protective film 9 is formed on dielectric layer 8.

Next, a method for manufacturing PDP1 will be described. First, scan electrodes 4, sustain electrodes 5, and light shielding layers 7 are formed on front glass substrate 3. In scan electrodes 4 and sustain electrodes 5, transparent electrodes 4a, 5a and metal bus electrodes 4b, 5b are respectively patterned and formed using such as a photolithography method. Transparent electrodes 4a, 5a are formed using such as a thin layer process, and metal bus electrodes 4b, 5b are formed by firing and solidifying a paste containing a silver (Ag) material at desired temperature. Also, light shielding layers 7 are formed by means of screen printing of a paste containing a black pigment, or by means of applying a black pigment on an entire surface of a glass substrate followed by patterning using a photolithography method and firing.

Next, a dielectric paste layer (dielectric material layer) is formed by applying a dielectric paste on front glass substrate 3 using such as a die coating method so as to cover scan electrodes 4, sustain electrodes 5, and light shielding layers 7. After applying the dielectric paste, the surface of the applied dielectric paste is left as it is for a predetermined period so as to be leveled to an even surface. After that, the dielectric paste layer is fired and solidified to form dielectric layer 8 which covers scan electrodes 4, sustain electrodes 5 and light shielding layers 7. Note that, the dielectric paste is a coating material which includes a dielectric material such as a glass powder, a binder, and a solvent. Next, protective film 9 composed of magnesium oxide (MgO) is formed on dielectric layer 8 by vacuum evaporation. With the aforementioned process, predetermined constituent members (scan electrodes 4, sustain electrodes 5, light shielding layers 7, dielectric layer 8, and protective film 9) are formed on front glass substrate 3, and thus front plate 2 is completed.

On the other hand, rear plate 10 is formed as follows. First, on rear glass substrate 11, material layers to be constituent members for data electrodes 12 are formed by means of screen printing of a paste containing a silver (Ag) material, or by means of forming a metal film on the entire surface of the substrate followed by patterning using a photolithography method. Then, the formed material layers are fired at desired temperature to form data electrodes 12. Next, a dielectric past layer is formed by applying a dielectric paste, using such as a die coating method, on rear glass substrate 11 having data electrodes 12 formed thereon, so as to cover data electrodes 12. After that, the dielectric paste layer is fired to form underlying dielectric layer 13. Note that, the dielectric paste is a coating material which includes a dielectric material such as a glass powder, a binder, and a solvent.

Next, barrier rib material layers are formed by applying a paste for barrier rib, which contains a barrier rib material, on underlying dielectric layer 13 and then patterning to a predetermined shape. Then, the patterned material layers are fired to form barrier ribs 14. Here, for pattering of the paste for barrier rib applied on underlying dielectric layer 13, a photolithography method or a sandblast method may be used. And then, phosphor layers 15 are formed by applying and firing phosphor pastes containing phosphor materials both on underlying dielectric layers 13 in between adjacent barrier ribs 14 and on side faces of barrier ribs 14. With the aforementioned process, rear plate 10 having predetermined constituent members on rear glass substrate 11 is completed.

PDP1 is then completed in this way: front plate 2 and rear plate 10 each thus provided with predetermined constituent members are disposed to face one another such that scan electrodes 4 orthogonally intersect with data electrodes 12; the peripheries thereof are sealed with a glass frit; a discharge gas including such as Ne and Xe is enclosed in discharge space 16.

Here, dielectric layer 8 of front plate 2 will be described in detail. The dielectric material of dielectric layer 8 contains 20 weight % to 40 weight % of bismuth oxide (Bi₂O₃) as a major component, and also contains 0.5 weight % to 12 weight % of at least one selected from calcium oxide (CaO), strontium oxide (SrO), and barium oxide (BaO), and further contains 0.1 weight % to 7 weight % of at least one selected from molybdenum oxide (MoO₃), tungsten oxide (WO₃), cerium oxide (CeO₂), and manganese dioxide (MnO₂), with these dielectric material being composed of lead-free components. Besides these materials, a lead-free material is mixed to constitute the dielectric material, which includes zero weight % to 40 weight % of zinc oxide (ZnO), zero weight % to 35 weight % of boron oxide (B₂O₃), zero weight % to 15 weight % of silicon oxide (SiO₂), and zero weight % to 10 weight % of aluminum oxide (Al₂O₃).

Moreover, the dielectric material is constituted so that dielectric layer 8 will be 40 μm or less in thickness and that a relative dielectric constant ∈ thereof will be 7 or less.

The dielectric material composed of these components is milled to an average particle size of 0.5 μm to 2.5 μm with a wet jet mill or a ball mill to prepare a dielectric material powder. Next, 55 weight % to 70 weight % of the dielectric material powder and 30 weight % to 45 weight % of a binder component are kneaded with a three-roll mill to prepare a paste for the dielectric layer, applicable to die coating or printing.

The binder component is either terpineol or butyl carbitol acetate which contains 1 weight % to 20 weight % of ethyl cellulose or acrylic resin. In addition, if necessary to improve printability, plasticizing agents of dioctyl phthalate, dibutyl phthalate, triphenyl phosphate, and tributyl phosphate may be added to the paste, and dispersing agents including glycerol monooleate, sorbitan sesquioleate, Homogenol (name of a product manufactured by Kao Corporation), alkylallyl phosphate ester may be added to the paste.

Next, the paste for dielectric layer is applied and dried on front glass substrate 3 by a die coating method or a screen printing method so as to cover display electrodes 6, and then fired at temperatures of 575° C. to 590° C., slightly higher than the softening point of the dielectric material, to form dielectric layer 8.

Now, a configuration of protective film 9 and a method for manufacturing thereof will be described, which characterize the PDP according to the technology disclosed herein.

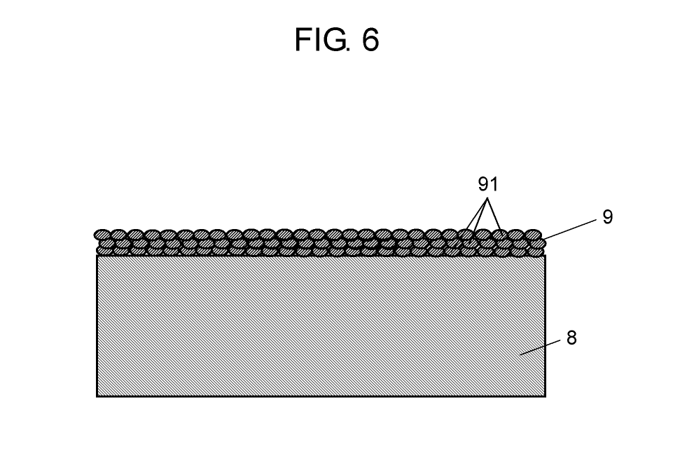

In the PDP according to the technology disclosed herein, as shown in FIG. 6, protective film 9 is characterized in that oxide particles 91 of a Group 2 element are disposed on dielectric layer 8, and that the film contains phosphorus.

That is, protective film 9 includes metal oxide particles of at least one of oxides of magnesium, calcium, and strontium, with diameters thereof from 5 nm to 500 nm, and also the film contains phosphorus.

Here, forming protective film 9 with metal oxide particles of at least one of magnesium, calcium, and strontium allows protective film 9 to be excellent in ion bombardment resistance and secondary electron emission capability. And, particle diameters of the metal oxide particles are preferably from 5 nm to 500 nm. Metal oxide particles with particle diameters smaller than 5 nm have a problem in stability of the particles, while metal oxide particles with particle diameters larger than 500 nm will cause a decrease in light transmission rate of protective film 9 leading to a possible decrease in brightness of PDP1; therefore, both are not preferable.

Moreover, in the technology disclosed herein, it is characterized in that protective film 9 contains phosphorus; the phosphorus content in protective film 9 allows a reduction in discharge starting voltage of PDP 1 and an improvement in operating life of protective film 9 associated with discharges. Such protective film 9 containing phosphorus can easily be formed in such a manner, for example, that: a paste is prepared composed of oxide particles of a Group 2 element such as MgO, and an inorganic phosphate of a Group 2 element or an organic phosphate compound; and the paste is applied on dielectric layer 8 and fired.

The inorganic phosphate includes orthophosphate, pyrophosphate, tripolyphosphate, tetraphosphate, and hexametaphosphate. And, use of the phosphate which contains a Group 2 element including magnesium, calcium, and strontium as a cation of the phosphate, allows prevention of a decrease in secondary electron emission capability of protective film 9.

The organic phosphate compound is an organic compound that has phosphoric groups in side chains thereof, and preferably has a molecular weight of less than 5000 in order to remove organic components in a subsequent firing process. Such compound includes, for example: DISPARLON PW36 of Kusumoto Chemicals, Ltd.; DISPERBYK-110, DISPERBYK-111, and DISPERBYK-180 of BYK Japan KK; and Phosmer M and Phosmer PE of Uni-Chemical Co., Ltd.

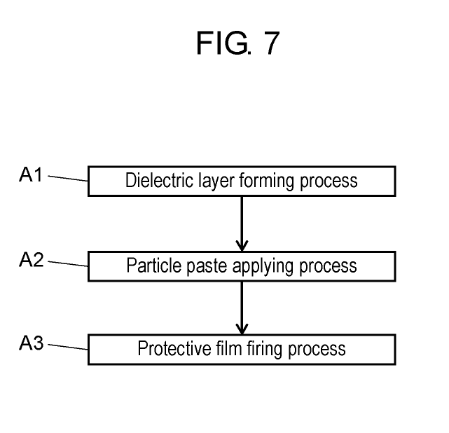

Next, in PDP 1 according to the technology disclosed herein, a manufacturing process for forming protective film 9 will be described, referring to FIG. 7.

As shown in FIG. 7, dielectric layer forming process A1 for forming dielectric layer 8 is performed, and then particle paste applying process A2 is performed. In the process A2, a paste is prepared which contains oxide particles of a Group 2 element, and a phosphate of a Group 2 element or an organic phosphate compound, and then applied on dielectric layer 8. Note that, for applying the particle paste, a screen printing method, a spraying method, a spin coating method, a die coating method, a silt coating method, or the like may be used.

A substrate having the applied particle paste on dielectric layer 8 is dried just after the application, and then fired at temperatures of several hundred degrees Celsius, in protective film firing process A3, thereby removing solvents and resin components that remain in the particle paste. This results in the formation of protective film 9 on dielectric layer 8, which includes oxide particles 91 of nanoparticle size and contains phosphorus.

Next, experiments that were performed to confirm an advantage of PDP 1 having protective film 9 according to the technology disclosed herein, will be described.

First, PDPs 1 having protective films 9 of different configurations were experimentally manufactured.

For Prototype 1, as an oxide of a Group 2 element which forms protective film 9, nanosized particles of magnesium oxide (an average particle diameter of 50 nm, U50 of Ube Material Industries, Ltd.) were used. A vehicle was prepared by mixing 45 weight % of terpineol, 45 weight % of butyl carbitol acetate, and 10 weight % of ethyl cellulose (100 cP). Then, a paste was prepared containing the vehicle, 10 weight % of the particles of magnesium oxide, and 5 weight % of magnesium phosphate. Note that, magnesium phosphate was an example of the phosphate. The prepared paste was applied on a substrate using such as a screen printing method, subjected to drying at from 100° C. to 120° C. for 60 minutes, and subjected to firing at from 450° C. to 500° C. for 60 minutes. Thus, protective film 9 was manufactured. Resulting protective film 9 was confirmed to contain 0.5 atomic % of phosphorus with an energy dispersive X-ray fluorescence spectrometer (EDX).

For Prototype 2, as oxide particles of a Group 2 element which form protective film 9, the same particles of magnesium oxide were used as for Prototype 1 described above. The same vehicle was prepared as for Prototype 1.

Then, a paste was prepared containing the vehicle, 10 weight % of the particles of magnesium oxide, 20 weight % of DISPERBYK112 (manufactured by Big Chemie Co.) as an organic phosphate compound. The prepared paste was applied on a substrate using such as a screen printing method, subjected to drying at from 100° C. to 120° C. for 60 minutes, and subjected to firing at from 450° C. to 500° C. for 60 minutes. Resulting protective film 9 was confirmed to contain 0.2 atomic % of phosphorus with an EDX.

Moreover, it was confirmed with an EDX that the amount of carbon in protective film 9 was substantially equal to that for the case where no organic phosphate compound was added. That is, organic components in the organic phosphate compound were confirmed to have substantially been vanished in the firing process described above.

For Prototype 3, as oxide particles of a Group 2 element which form protective film 9, the same particles of magnesium oxide were used as of Prototype 1 described above. The same vehicle was prepared as of Prototype 2. Then, a paste was prepared containing the vehicle, 10 weight % of the particles of magnesium oxide, 100 weight % of DISPERBYK112 (manufactured by Big Chemie Co.) as an organic phosphate compound. The prepared paste was applied on a substrate using such as a screen printing method, subjected to drying at from 100° C. to 120° C. for 60 minutes, and subjected to firing at from 450° C. to 500° C. for 60 minutes. Resulting protective film 9 was confirmed to contain 1 atomic % of phosphorus with an EDX. Moreover, it was confirmed with an EDX that the amount of carbon in protective film 9 was substantially equal to that for the case where no organic phosphate compound was added. That is, organic components in the organic phosphate compound were confirmed to have substantially been vanished in the firing process described above.

Next, Prototypes 4 and 5 were experimentally manufactured which have phosphorus contents different from those of Prototypes 1 to 3 described above. Note that, as oxide particles of a Group 2 element which form protective film 9, the same particles of magnesium oxide were used as of Prototype 1 described above. Pastes were prepared in the same manner as for Prototype 2 except for different contents of the organic phosphate compound, and thus protective films 9 were manufactured. The content of phosphorus in Prototype 4 was adjusted to 0.01 atomic %, and the content of phosphorus in Prototype 5 was adjusted to 5 atomic %.

In addition, as a comparative example, Prototype 6 of PDP 1 was manufactured having protective film 9 to which no phosphorus was added. Note that, for Prototype 6, protective film 9 was manufactured in the same manner as for Prototype 1: the same particles of magnesium oxide were used as of a Group 2 element; the same vehicle was prepared as of Prototype 1; a paste was prepared by adding 10 weight % of the particles of magnesium oxide to the vehicle; and the prepared paste was applied on dielectric layer 8 using such as a screen printing method, subjected to drying at from 100° C. to 120° C. for 60 minutes, and subjected to firing at from 450° C. to 500° C. for 60 minutes.

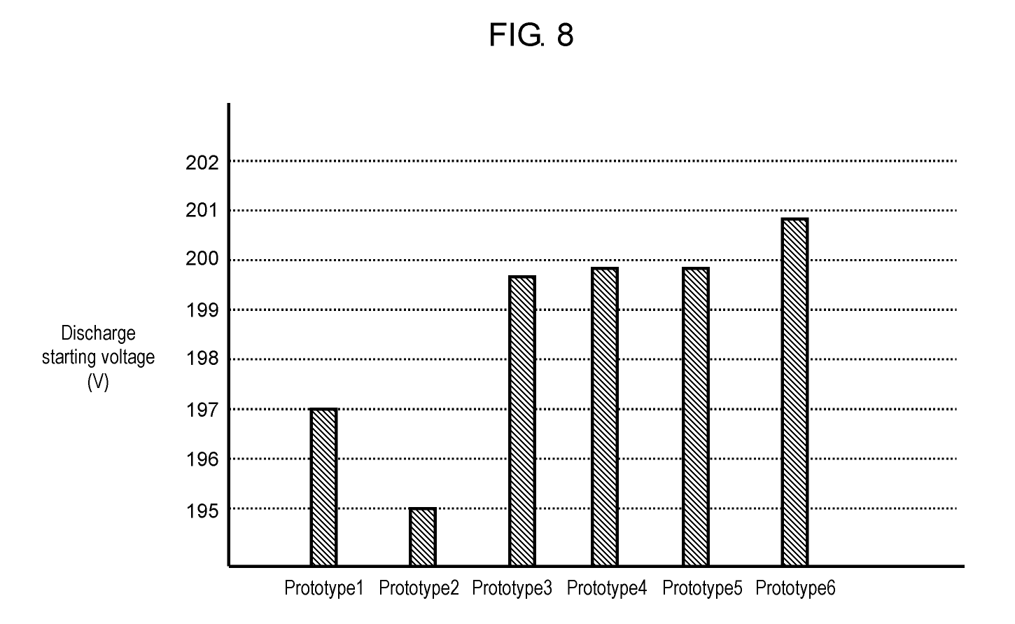

FIG. 8 shows the results from measurements of resulting Prototypes 1 to 5 for their discharge starting voltages, together with Prototype 6 as a comparative example.

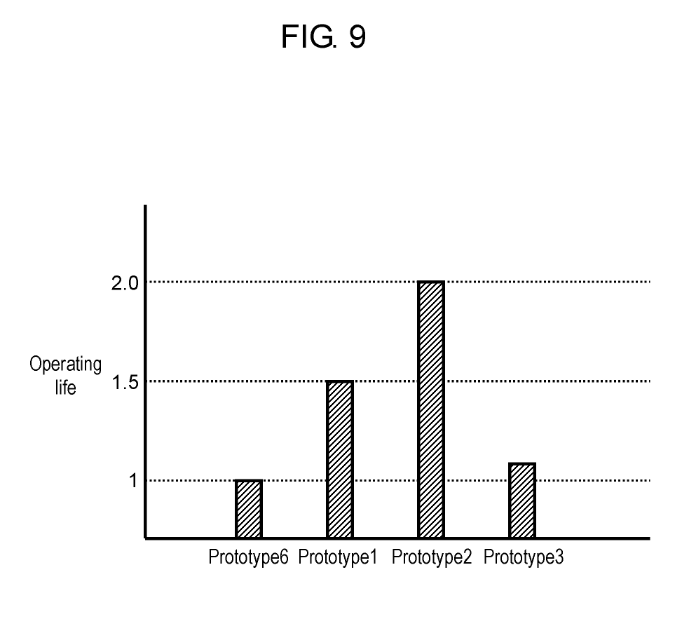

Also, FIG. 9 shows evaluated operating lives associated with discharges of Prototypes 1 to 3 and Prototype 6 as a comparative example. Note that, the operating lives are determined from brightness degradation rates that were determined from accelerated discharge evaluations. Specifically, sustain pulses of a cycle eight times higher than of usual ones were applied to resulting PDPs 1 to generate discharges, and brightness degradation rates thereof were measured after the discharges of 250 hours. Then, brightness degradation rates corresponding to those of 2000 hours are determined by calculation using the measured rates. In FIG. 9, operating lives of the Prototypes are represented as ratios, i.e., each of which is a ratio of the 2000 hour-corresponding brightness degradation rate of each Prototype to that of Prototype 6 as a comparative example having a normative rate of “one.”

As shown in FIG. 8, Prototypes 1 to 5 having the protective films which included the oxide particles of the Group 2 element and contained phosphorus therein, were made to exhibit reduced discharge starting voltages, in comparison with Prototype 6 as a comparative example that did not contain phosphorus. Concerning operating life, Prototypes 1 to 3 were made to exhibit longer operating lives than Prototype 6 as a comparative example. These aforementioned experimental results show that protective film 9 formed on dielectric layer 8 can be made to provide a lower discharge starting voltage and a longer operating life of PDP 1 when the film includes oxide particles of a Group 2 element and contains phosphorus therein, in comparison with the case where the film does not contain phosphorus.

The result is considered to be attributed to the film structure of protective film 9 in which oxide particles are deposited in a dense state, which is obtained when phosphorus is contained in protective film 9 including oxide particles.

Note that, the content amount of phosphorus in protective film 9 including oxide particles of a Group 2 element is preferably in a range from 0.01 atomic % to 5.0 atomic %, and particularly, the content amount of phosphorus in a range from 0.2 atomic % to 1.0 atomic % results in a more preferable functional advantage. Moreover, when the content amount of phosphorus in protective film 9 is in a range from 0.2 atomic % to 0.5 atomic %, a further more preferable result can be obtained in discharge starting voltage and operating life.

As described above, the technology disclosed herein provides PDP 1 which includes: front plate 2 having dielectric layer 8 that is formed to cover display electrodes 6 formed on a substrate, and protective film 9 that is formed on dielectric layer 8; and rear plate 10 disposed to face front plate 2 so as to form discharge space 16, which has data electrodes 12 formed in a direction intersecting display electrodes 6 and has barrier ribs 14 for partitioning discharge space 16. And, protective film 9 is formed by applying and firing a paste that contains oxide particles of a Group 2 element, and a phosphate of a Group 2 element or an organic phosphate compound. Moreover, phosphorus is contained in protective film 9 including the oxide particles of a Group 2 element. Thereby, the protective film can be formed by a simple process without use of expensive equipment including a vacuum deposition apparatus. In particular, since phosphorus is contained in protective film 9 including oxide particles of a Group 2 element, a reduced discharge starting voltage and a lengthened operating life can be achieved.

By the way, in a method where a MgO film is formed by applying and firing a paste of protective film materials, a method is known of adding a coupling agent containing Ti, Zr, and Al to improve discharge characteristics; however, such coupling agent is generally unstable in the atmosphere, causing a safety problem in handling, and is expensive and difficult to use in a low-cost volume production.

In contrast, the technology disclosed herein includes a method where protective film 9 is formed by applying and firing a paste that contains oxide particles of a Group 2 element, and a phosphate of a Group 2 element or an organic phosphate compound; therefore, the technology can be performed safely and inexpensively. That is, the technology can provide an effective manufacturing method of PDP 1 in a low-cost volume production.

It should be noted that, in the aforementioned description, although MgO is illustrated to exemplify protective film 9, oxide particles other than magnesium oxide may be used as oxide particles of a Group 2 element, i.e., metal oxide particles composed of an oxide of at least one of magnesium, calcium, and strontium will provide the same functional advantage.

### INDUSTRIAL APPLICABILITY

The technology disclosed herein is, as described above, useful for providing PDPs of excellent display performances at low cost.

### DESCRIPTION OF REFERENCE MARKS

1 PDP
2 front plate
3 front glass substrate
4 scan electrode
4a transparent electrode
4b metal bus electrode
5 sustain electrode
5a transparent electrode
5b metal bus electrode
6 display electrode
7 light shielding layer
8 dielectric layer
9 protective film
91 oxide particle
10 rear plate
11 rear glass substrate
12 data electrode
13 underlying dielectric layer
14 barrier rib
15 phosphor layer
16 discharge space
21 image signal processing circuit
22 data electrode driving circuit
23 scan electrode driving circuit
24 sustain electrode driving circuit
25 timing generating circuit

1. A plasma display panel comprising:
a front plate including a dielectric layer formed over display electrodes formed on a substrate, and a protective film formed on the dielectric layer; and
a rear plate disposed facing the front plate so as to form a discharge space, the rear plate including a data electrode formed in a direction intersecting the display electrodes, and barrier ribs partitioning the discharge space,
wherein the protective film includes oxide particles of a Group 2 element and contains phosphorus.

2. The plasma display panel according to claim 1, wherein the oxide particles of the Group 2 element are metal oxide particles composed of an oxide of at least one of magnesium, calcium, and strontium.

3. The plasma display panel according to claim 1, wherein a particle diameter of the oxide particles is from 5 nm to 500 nm.

4. The plasma display panel according to claim 1, wherein a concentration of phosphorus contained in the protective film is from 0.01 atomic % to 5 atomic %.

5. A method for manufacturing a plasma display panel, the plasma display panel comprising:
a front plate including a dielectric layer formed over display electrodes formed on a substrate, and a protective film formed on the dielectric layer; and
a rear plate disposed facing the front plate so as to form a discharge space, the rear plate including a data electrode formed in a direction intersecting the display electrodes, and barrier ribs partitioning the discharge space,
wherein the protective film is formed by applying and firing a paste including oxide particles of a Group 2 element and one of a phosphorus of a Group 2 element and an organic phosphorus compound.

6. The method for manufacturing a plasma display panel according to claim 5, wherein a molecular weight of the organic phosphorus compound is 5000 or less.

7. The method for manufacturing a plasma display panel according to claim 5, wherein the oxide particles of the Group 2 element are metal oxide particles composed of an oxide of at least one of magnesium, calcium, and strontium.

8. The method for manufacturing a plasma display panel according to claim 5, wherein a particle diameter of the oxide particles is from 5 nm to 500 nm.

9. A plasma display apparatus comprising:
a plasma display panel including:
a front plate including a dielectric layer formed over display electrodes formed on a substrate, and a protective film formed on the dielectric layer;
a rear plate disposed facing the front plate so as to form a discharge space, the rear plate including a data electrode formed in a direction intersecting the display electrodes, and barrier ribs partitioning the discharge space; and
a plurality of discharge cells,
wherein the plasma display apparatus performs light-emitting display in such a manner that one field is composed of a plurality of subfields, and that each of the subfields includes: an address period for generating an address discharge to select a discharge cell which should emit light; and a sustain period for generating a sustain discharge in the discharge cell selected during the address period, and
wherein the protective film of the plasma display panel includes oxide particles of a Group 2 element and contains phosphorus.

10. The plasma display apparatus according to claim 9, wherein the oxide particles of the Group 2 element are metal oxide particles composed of an oxide of at least one of magnesium, calcium, and strontium.
